(19) United States
(12) Patent Application Publication
(10) Pub. No.: US 2025/0187979 A1
(43) Pub. Date: Jun. 12, 2025

(54) Method for Producing Lightweight Concrete Mixtures Using Lightweight Aggregates

(71) Applicant: B-ton IP GMBH, Soltau (DE)

(72) Inventor: Thomas SIEVERS, Hamburg (DE)

(21) Appl. No.: 18/725,095

(22) PCT Filed: Dec. 31, 2021
(86) PCT No.: PCT/EP2021/087908

§ 371 Date: Jun. 27, 2024

(51) Int. Cl. C04B 28/00; C04B 14/04; C04B 18/08; C04B 28/08; C04B 40/00; C04B 103/30; C04B 111/40

(52) U.S. Cl. CPC C04B 28/008; C04B 14/04; C04B 18/08; C04B 28/082; C04B 40/0032; C04B 40/0042; C04B 40/0057; C04B 2103/304; C04B 2111/40; C04B 2201/20

(57) ABSTRACT

The invention provides a method for producing lightweight concrete mixtures using lightweight aggregates, comprising an at least two-stage mixing process, where first a suspension mixture comprising the binder composition is prepared by high-speed stirring with a cement or a geopolymer and water and then the suspension mixture is mixed by low-speed stirring with constituents including the lightweight aggregates. The invention also embraces lightweight concretes and lightweight concrete mixtures produced accordingly. Binder composition candidates include, for example: —60-80 wt % finely ground slag sand cement, 10-60 wt % fly ash—2-25 wt % alkali metal hydroxides/alkali metal silicates, 75-98 wt % finely ground slag sand—2-20 wt % alkali metal hydroxides/alkali metal silicates, 60-78 wt % finely ground slag sand—20-38 wt % fly ash cement, 30-50 kg/m (in the lightweight concrete mixture) microsilica cement, 10-60 wt % rice husk fly ash cement, 1-5 wt % caustic calcined CaO/MgO

The method according to the invention for producing lightweight concrete mixtures using lightweight aggregates comprises an at least two-stage mixing process, wherein a suspension mixture containing the binder composition is produced initially by high-speed stirring with a cement or a geopolymer and water, and the suspension mixture is then mixed by low-speed stirring with the lightweight aggregates, among other things. The invention likewise comprises lightweight concrete mixtures and lightweight concretes produced in this way.

### General Prior Art

Concrete has a defined relative density starting at 2,000 kg/m³ to 2,600 kg/m³, measured as dry gross density with a minimum compression strength of 8 N/mm². Lightweight concrete is defined as concrete with a dry gross density of below 2,000 kg/m³. In the case of lightweight concretes, the low densities are reached, e.g., with the admixture of lightweight aggregates. The lower the density of the lightweight aggregates, the lower the density of lightweight concrete produced therefrom can become. Lightweight aggregates have bulk densities of, e.g., 40 to 1200 kg/m³.

Lightweight concrete is used to produce building products. Firstly, the lightweight concrete is a building material prior to the shaping, and a component after the at least partial hardening. Components are produced in order to be permanently installed in physical structures. Structures manufactured from building materials and components, which are produced to be connected to the ground, such as, for example, buildings, are likewise among the building products. Buildings can be prefabricated houses, prefabricated garages, and silos, or also so-called “temporary structures”, which are suitable to be set up repeatedly and temporarily and to be dismantled again at various locations. Typical components are lightweight concrete wall elements or lightweight concrete ceiling elements or lightweight concrete bricks.

With compression strengths of 2 to above 100 N/mm² (according to DIN EN 1520, DIN 4213, DIN EN 206-1, or DIN 1045-2), the components can be adapted in a differentiated manner to the different building requirements

Lightweight concrete is suitable for exterior and interior walls, from the basement to the roof, for apartment buildings as well as for agricultural, public, or industrial buildings and bridges. Lightweight building boards for insulation purposes or fire protection, etc., the compression strength of which can also be lower, can also be made of lightweight concrete.

The component made of lightweight concrete is to have a high ratio of the compression strength to the dry gross density. The dimensionless so-called A number follows from a computational relationship of the compression strength to the dry gross density. The A number is described by Siegfried G. Zurn in “Einfluss der Sandminerale auf die Bildung von Calciumsilikathydraten (CSH-Phasen), das Gefüge und die mechanischen Eigenschaften von Porenbetonprodukten”, Logos-Verlag, Berlin, 1997. It represents the relative compression strength. The larger the A number, the better the compression strength level. The A number is calculated as follows:

A number=compression strength (in N/mm²): [dry gross density (kg/dm³)²·0.016].

The lower weight of the component or of the building material during the transport by means of, e.g., trucks or ready-mixed concrete truck mixers, respectively, simplifies and reduces the costs of the transport to the construction site, decreases the CO₂ emission due to additional load capacity, and provides for quick and precise work. Short construction times can be attained especially with prefabricated elements made of lightweight concrete-they can be factory-produced with integrated supply lines, doors, and windows as well as finished surfaces. Additionally, the lightweight elements can also be transported to construction sites in a difficult location.

What applies in the case of components is that the higher the weight, the higher the sound insulation index. In spite of its very low weight, components made of lightweight concrete have a high sound absorption, i.e., a good sound protection capacity.

The water absorption of lightweight aggregates, thus the suction behavior, has influence when being used as aggregate in the lightweight concrete. The higher and faster the water absorption, the more problematic the effect of the behavior can be during the production of lightweight concrete because water is removed from the mixture and is thus no longer available for the binders and the processability.

In practice, there was no shortage of tests for also using lightweight aggregates of a low bulk density and grain strength for the use in building materials, such as wall and ceiling elements and bricks. Until now, such a use failed in particular due to the high absorption capacity of these lightweight aggregates, which has the result that when simultaneously mixing the lightweight aggregates with cement, water is removed from the cement. A low grain strength is problematic because, when mixing in industry-standard concrete mixers, it has the result that the lightweight aggregates are comminuted during the mixing process, thus reaching a larger surface, with the result that the water and binder need increases further and the density of the end products thus also increases unintentionally, in addition to other unfavorable properties, such as larger degree of shrinkage and risk of cracking.

### OBJECT OF THE INVENTION

The invention is based on the object of providing a lightweight concrete for producing building products, which can also be produced using lightweight aggregates with a low grain strength and bulk density, wherein the lightweight concrete is to have dry gross densities (measured according to DIN EN 12390-7 in the heating cabinet at 105° C.) of 200 kg/m³ to 1999 kg/m³ and compression strength from of 0.5 N/mm² to greater than 100 N/mm².

Components made of the lightweight concrete are to have low dry gross densities, improved heat insulation values, and very good sound insulation values as well as a final strength, which is high compared to the density, with an A number of greater than 500, due to the production type.

For the CO₂ reduction, a binder is to be capable of being used during the production of the lightweight concrete, such as a geopolymer or a cement with low clinker portion and a high portion of substitutes, such as ground granulated blast furnace slag.

### SUMMARY OF THE INVENTION

To date, this goal could not be achieved by means of conventional mixing processes and mixing procedures using the known compulsory and free-fall mixers.

The object of the invention is defined in the independent patent claims. Preferred embodiments are subject matter of the subclaims or are described below. In addition to the production of the lightweight concrete mixture and of the lightweight concrete, the invention also relates to a lightweight concrete mixture and the lightweight concrete hardened in a mold.

The method for producing a lightweight concrete mixture comprises at least the following steps:
(A) bringing together at least water and a binder composition, in particular in the absence of the lightweight aggregates,
   wherein the binder composition comprises at least cement or geopolymers as binders, wherein the water is preferably added first and the binder composition is added by mixing, and
mixing with a high-speed stirring tool for producing a suspension mixture,
wherein the weight ratio of water to binder composition in the suspension mixture is 1:5 to 1:1, in particular 1:2 to 2:3;
wherein the binder accounts for at least 40% by weight of the binder composition, preferably at least 50% by weight;
wherein the binder is added as powdery solid; and
(B) bringing together the suspension mixture or portions of the suspension mixture with at least lightweight aggregates or portions of the lightweight aggregates, wherein at least the lightweight aggregates are preferably added first and the suspension mixture is added by mixing, and
mixing with a low-speed stirring tool for producing a lightweight concrete mixture;
wherein the lightweight aggregates have a bulk density of 40 to 1000 kg/m³, preferably between 50 to 500 kg/m³, and in particular 60 to 300 kg/m³; and
wherein the mixing with the high-speed stirring tool takes place at a circumferential speed, which is more than three times as high as the circumferential speed when mixing with the low-speed stirring tool
and/or according to another definition;
wherein the mixing with the high-speed stirring tool is carried out with a Froude number of greater than 10 and in particular greater than 25, and wherein the mixing with the low-speed stirring tool is carried out with a Froude number of less than 2.5 and in particular less than 1.5.

Step A and step B take place by mixing with different input of mixing energy, namely with a high-speed stirring tool (A) and with a low-speed stirring tool (B).

Step A is preferably carried out, e.g., for 60 to 360 sec., in particular 120 to 240 sec. (starting after the addition of the cement/geopolymer), and, independently thereof, step B for at least 120 sec., in particular 180 to 360 (starting after the addition of the suspension mixture).

The “mixing water” is first brought into contact with the cement or geopolymer, respectively, in this way, including the further substances of the binder composition and is “unlocked” by mixing with a high-speed stirring tool to obtain the suspension mixture before the generally absorbent lightweight aggregates come into contact with the mixing water. The lightweight aggregates are then brought into contact with the suspension mixture. It was surprisingly found that the water is then better available for the water-cement reaction or geopolymer-water reaction, respectively, and the lightweight aggregates no longer start to compete here for the availability of the water. In sum, less water can thus be used.

The method according to the invention comprises at least two mixing processes:
the mixing of water and binder composition, comprising at least cement or geopolymers in the absence of the lightweight aggregates for producing a suspension mixture and
the bringing together of the suspension mixture with at least lightweight aggregates and mixing to obtain a lightweight concrete mixture.

The binder or the binder composition, respectively, is preferably added only to the suspension mixture.

After the mixing in step A, the suspension mixture has a flowability of at least F6. 22 to 40% by weight of water is preferably added to the suspension mixture or the suspension mixture preferably contains 22 to 40% by weight of water, respectively.

The binder composition for producing the suspension mixture can contain:
cement as binder and fly ash as binder additive, in particular 10 to 60% by weight based on the binder composition;
cement as binder and micro silica as binder additive, in particular 30 to 50 kg/m³ based on the lightweight concrete mixture;
cement as binder and rice husk fly ash prepared by means of grinding as binder additive, in particular 10 to 60% by weight based on the binder composition.

Alternatively, the binder composition can be a geopolymer, comprising 2 to 25% by weight of alkali hydroxides and/or alkali silicates and 75 to 98% by weight of ground granulated blast furnace slag or 2 to 20% by weight of alkali hydroxides and/or alkali silicates and 60 to 78% by weight of ground granulated blast furnace slag and 20 to 38% by weight of fly ash.

The following can be provided first or added during the production of the suspension mixture:
rock flour as filler, in particular with particle diameters of 0.001 mm to 0.1 mm, preferably up to 0.063 mm, and/or
0.1 to 4% by weight, preferably 0.5 to 2% by weight of plasticizer.

It is preferred that fillers in the form of rock flour and/or rock particles 0-2 mm are added and the mixing with the high-speed stirring tool is then preferably temporarily carried out with a Froude number of greater than 50 and in particular greater than 100, in particular for at least 30 sec, particularly preferably at least 60 sec, wherein the rock flour is preferably added in a quantity of 50 to 150 kg per m³ of lightweight concrete mixture and wherein the rock particles 0-2 mm are preferably added in a quantity of 100 to 500 kg per m³ of lightweight concrete mixture.

The lightweight aggregates can have a grain size in the range of 0 mm to 6 mm, as grain groups in particular of 0 to 2 mm, 0 mm to 3 mm, 3 to 5 mm, or 2 to 8 mm in each case according to DIN EN 13055. Prior to adding the suspension mixture, a hydrophobing agent can be applied to the lightweight aggregates, the lightweight aggregates can additionally or alternatively be wetted with water, in particular by spraying, prior to adding the suspension mixture.

The lightweight concrete preferably has a dry gross density between 250 and 1999 kg/m³ and also independently thereof an A number of greater than 500.

The lightweight concrete mixture can be introduced into block molding machines in molds and can be compressed by shaking and/or pressing, in order to produce lightweight concrete in the form of lightweight concrete blocks therefrom.

The lightweight concrete mixture has, e.g., the following components (based on the total mass of the lightweight concrete mixture):
binder composition in the range of 10 to 90% by weight, thus for example also in the range of 25 to 85% by weight or in the range of 40 to 80% by weight;
lightweight aggregates in the range of 1 to 50% by weight, thus for example also in the range of 5 to 30 or in the range of 5 to 15% by weight;
water in the range of 20 to 40% by weight, thus for example also in the range of 20 to 35% by weight;
optionally further components, such as concrete additives in the range of 0 to 65% by weight, thus for example also in the range of 20 to 60% by weight or in the range of 10 to 30% by weight.

A lightweight concrete mixture by additionally using rock particles, in particular rock particles 0 bis 8 mm, comprises the following components (based on the total mass of the lightweight concrete mixture):
binder in the range of 15 to 70% by weight, thus for example also in the range of 20 to 60% by weight or in the range of 25 to 55% by weight;
lightweight aggregates in the range of 3 to 40% by weight, thus for example also in the range of 5 to 20 or in the range of 1 to 15% by weight;
rock particles in the range of 5 to 65% by weight, thus for example also in the range of 20 to 60% by weight, in the range of 30 to 60% by weight, or in the range of 40 to 60% by weight;
water in the range of 10 to 40% by weight, thus for example also in the range of 13 to 35% by weight;
optionally further components, such as concrete additives (expect for rock particles) in the range of 0 to 20% by weight, thus for example also in the range of 2 to 15% by weight.

The lightweight aggregates can advantageously initially be brought into contact with a portion of the suspension mixture as part of step B, wherein the lightweight aggregates are preferably added first and the further portions of lightweight aggregates and suspension mixture are then added jointly or sequentially in one or several steps by mixing according to step B. This can take place so that initially 20 to 70% by weight, in particular 40 to 60% by weight, of the lightweight aggregates with 20 to 70% by weight, in particular 40 to 60% by weight, of the suspension mixture are subjected to the mixing with the low-speed stirring tool according to B and the remaining lightweight aggregates and the remaining suspension mixture are added subsequently in one or several steps by continuing the mixing with the low-speed stirring tool according to B.

### DETAILED DESCRIPTION OF THE INVENTION

The following raw materials can be used to produce the lightweight concrete mixture:

The binder composition consists of the binder and optionally the binder additive. The binder and generally also the binder additive is present as powdery solid.

Binders for the method according to the invention are cement and geopolymers.

“Cement” or “cements”, respectively, are inorganic, finely ground substances, which independently solidify and harden (hydraulic setting) after being mixed with water as a result of chemical reactions with the mixing water. From a chemical aspect, cement is mainly calcium silicate with portions of aluminum and iron compounds, which is present as complicated substance mixture. The raw materials for producing cement are limestone (calcium carbonate as source for calcium oxide), clay (for silicon dioxide and aluminum oxide), sand (for silicon dioxide), and iron ore (iron (III) oxide). The raw materials are ground and superheated until they partially fuse together (sinter) at the grain boundaries and the so-called cement clinker is created. The latter is cooled down and is ground to form the end product.

Geopolymers are two-component systems, consisting of a reactive solid, which contains silicon and aluminum oxides, as well as an alkaline-based activating solution of alkali hydroxides or silicates in water. Geopolymers can also be produced from ground granulated blast furnace slag and/or fly ash or a mixture thereof, wherein they are alkali-activated with alkali hydroxides and/or alkali silicates. The activating solution comprises, e.g., sodium, potassium, and/or lithium water glass, particularly preferably potassium water glass.

Fly ashes, ground granulated blast furnace slag, amorphous silicon dioxide, such as micro silica, pozzolans (optionally together with calcium hydroxide), burnt shale, calcium oxide and magnesium oxide, ground perlite, trass, and graphene are suitable as binder additives.

Silica dust or Microsit® (BauMineral GmbH, Herten, Germany) can be used as amorphous silicon dioxide. The pozzolans are available, e.g., as finely ground perlite with a grain size of smaller than 45 μm.

Fly ashes in terms of this invention are, e.g.: silicic acid- or lime-rich dust-like particles, which are deposited in electrostatic precipitators for the exhaust gas purification of coal-fired power plants. Silicic acid-rich fly ashes mainly consist of spherical, glassy particles with pozzolanic properties and generally originate from hard coal-fired power plants. Lime-rich fly ashes are fine-grained dusts with hydraulic and/or pozzolanic properties. They mainly originate from lignite combustion plants. Fly ashes can also be ground more finely to increase the reactivity.

Rice husk fly ash can also be used as fly ash. Rice husk fly ash can be obtained in that the rice husk surrounding the grain, also referred to as husk, is separated from the raw rice in a rice mill. These husks are burned as energy source. The ash, which can be obtained in this way, is rice husk fly ash and contains a high portion of amorphous silicon dioxide.

Blast furnace slag results when melting iron ore in the blast furnace. Granulated blast furnace slag, a predominantly glassily solidified, latently hydraulic substance, is created by means of granulation, i.e., by means of quick cool-down of the liquid slag, which is up to 1,500° C.

Finely ground, granulated blast furnace slag as ground granulated blast furnace slag develops hydraulic properties in response to corresponding excitation (e.g., by means of the calcium hydroxide from the cement clinker).

Silica gel, silica dust or micro silica are used as particulate solids or suspensions in water. They consist in particular of very fine, spherical particles with a high content (above 85% by weight) of amorphous silicon dioxide. Silica dust is created as filter dust during the production of silicon or silicon alloys. The starting material for this is Quartz, which, together with coal, is melted in electric furnaces at temperatures starting at 2500° C.

Pozzolans (P, Q) in terms of this invention are substances containing silicic acid or silicic acid and alumina from natural sources. They are of volcanic origin (e.g., trass, lava) or are obtained from clays, slate, or sedimentary rock (phonolite). Pozzolans do not have a separate hardening capability. They react to form firmness-forming and water-insoluble compounds only when they come into contact with calcium hydroxide (for example from the Portland cement clinker) after being mixed with water. Pozzolans are used as natural pozzolan or as natural tempered (thermally treated) pozzolan (e.g., phonolite) for the cement production.

Burnt shale, in particular burnt oil shale, is produced in a special furnace at temperatures of approximately 800° C. from natural shale deposits. Finely ground, burnt shale has pronounced hydraulic, but in addition also pozzolanic properties.

Calcium oxide (CaO) and magnesium oxide (MgO) in terms of this invention are finely ground substances, which are subject to different burning temperature and grinding fineness during the production. A differentiation is generally made between calcination, medium burn (also referred to as caustic), and hard burn. Different reactivities, which have impacts with regard to the use according to this invention, are obtained with the burning temperature. The reaction processes in the case of the calcination after water contact are, for example, quick and severe, slower in the case of the medium burn.

The use of caustically burnt products in the lightweight concrete already effects an expansion in the setting phase, but also in the hardened state and thus counteracts a crack formation and decreases the shrinkage behavior. Hard burnt materials do not attain these properties. This is why only caustically burnt calcium oxide (CaO) and caustically burnt magnesium oxide (MgO) are used as binder additives according to this invention.

Finely ground perlite with a grain size of smaller than 45 μm is suitable as pozzolanic additive in exchange for cement, in particular when the water-to-cement value (W/C value) is below 0.40, preferably below 0.35. It has been found that up to 35% by weight of cement can be exchanged, without the occurrence of a loss of strength compared to mixtures with 100% by weight of cement. The exchange also has a positive effect with regard to the dry gross density as well as the shrinkage behavior, both decreases.

Graphene can also be added to the binder composition. With already low addition amounts of 75 to 650 g/m³ per m³ of lightweight concrete mixture, the addition of graphene already effects a significant increase of the strength, an accelerated hardening, as well as a strongly decreased water absorption. Graphenes are two-dimensional, but can also be added in preferred form with several layers, e.g., up to 5 or up to 10 layers

By adding additives, such as, e.g., ground granulated blast furnace slag, pozzolan or fly ash, binder compositions with different chemical and physical properties can be produced. According to DIN EN 197-1, a differentiation is made between five main cement types:
1. Portland clinker cements CEM I
2. Portland composite cements CEM II
3. Blast furnace cements CEM III
4. Pozzolan cements CEM IV
5. Composite cements CEM V
   wherein 2. to 5. represent binder compositions because they also contain ground granulated blast furnace slag portions or other binder additives, respectively.

All of the listed cement types according to DIN EN 197-1 contain between 20 and 100% by weight of cement clinker.

From an ecological aspect, it is particularly advantageous to use binder compositions during the concrete production, in the case of which the energy-intensive Portland cement clinker portion is as low as possible. The lowest Portland cement clinker portion is at hand in the case of CEM III, which is additionally divided into CEM III A (35 to 65% by weight of ground granulated blast furnace slag portion) CEM III B (66 bis 80% by weight of ground granulated blast furnace slag portion) and CEM III C (81 to 85% by weight of ground granulated blast furnace slag portion).

According to the prior art, the significantly slower strength development compared to CEM I and CEM II is a disadvantage during the concrete production with CEM III, which causes significantly extended stripping times during the production of precast concrete parts. According to the method according to the invention, however, surprising early strengths are attained, which are in no way inferior to the early strengths of CEM I or CEM II cements.

According to the present invention, it is thus preferred to use cements or binder compositions, respectively, with a ground granulated blast furnace slag portion of greater than 35% by weight, in particular of greater than 65% by weight, in particular CEM III A and CEM III B cements.

Mixtures of cements or binder compositions, respectively, e.g., cements of the CEM series, with, e.g., up to 70% by weight of fly ash and/or up to 10% by weight of micro silica can also be used. According to a different design, cements or binder compositions, respectively, are mixed with rice husk fly ash, among others, e.g. up to 70% by weight. Finely ground pozzolans can be added up to 35% by weight.

Lightweight aggregates can in particular be used alone or in mixture. According to the invention, lightweight aggregates with low bulk densities of 40 to 1000 kg/m³, preferably of 50 to 500 kg/m³, or of 60 to 300 kg/m³, can be used, the bulk density is determined according to DIN EN 1097-3. When the term “lightweight aggregates” (in the plural) is used below, this can be an essentially chemically uniform or several different lightweight aggregates. The term “lightweight aggregates” thus also comprises the term “lightweight aggregate”.

In terms of this invention, a low grain strength means that it is smaller than 1 N/mm². An average grain strength means that it is 1 to 5 N/mm². High grain strengths are those above 5 N/mm². According to the method according to the invention, lightweight aggregates with a low grain strength of below 1.0 N/mm² can also be used. The grain strength is determined according to DIN EN 13055 (Annex C).

Suitable lightweight aggregates also in mixture are (including exemplary explanation):

Pumice: Pumice is a porous glassy volcanic rock. Pumice was created by gas-rich volcanic eruptions, during which the ejected magma was foamed. Such lightweight aggregates have, for example, average to high grain strengths and bulk densities between 400-700 kg/m³.

Expanded clay: Expanded clay is an industrially produced lightweight aggregate made of expandable clay. Expanded clay is characterized, e.g., by its round grain form. Expanded clay can be obtained, e.g., in that clay is dried, ground, and made to expand at approx. 1200° C. and is burned into small beads. Depending on the production, expanded clay has low to high grain strengths and bulk densities between 220 to 600 kg/m³.

Expanded shale: Expanded shale is a mineral lightweight aggregate produced from the natural raw material shale by means of a thermal process. It is characterized by a compact, flat to angular grain shape and is available with closed or open-pored surface, depending on whether or not a crushing process takes place after the burning. Expanded shale has average to high grain strengths and bulk densities between 300 to 800 kg/m³.

Volcanic cinder: Volcanic cinder is a hard, volcanic rock, which is crushed and delivered according to the desired fractions. Volcanic cinder as a high grain strength and bulk densities between 800 to above 1000 kg/m³.

Sintered hard coal fly ash: Sintered hard coal fly ash is created during the combustion of dust-shaped hard coal in modern power plants. By means of pelletization and subsequent sintering of the beads, a lightweight aggregate with a round grain shape and closed surface is created. Sintered hard coal fly ash has an average to high grain strength and bulk densities between 400 to 800 kg/m³.

Furnace bottom ash: Furnace bottom ash is created during the combustion of hard coal in the dry combustion boilers of power plants. Furnace bottom ash is a sintered product cooled down in the water, of the non-combustible mineral components of the hard coal. Furnace bottom ash has an average grain strength and bulk densities between 400 to 800 kg/m³.

Expanded glass: Expanded glass is a purely mineral, fiber-free lightweight aggregate made of recycling glass. The waste glass is ground into glass powder and is expanded at approx. 900° C. It is generally characterized by a round grain shape and a closed surface. Expanded glass has a low to average grain strength and bulk densities between 200 to 400 kg/m³.

Expanded mica: Expanded mica belongs to the clay minerals, it is created by the thermal processing of mica shist, a mineral created by weathering. Expanded mica can be obtained, e.g., by expanding vermiculite and has a low grain strength and bulk densities between 60 to 200 kg/m³.

Expanded perlite: Expanded perlite is produced from crude perlite expanded in heat. For example, crude perlite grains with a diameter of 0.2 mm to 1.2 mm can be heated abruptly in a vertical furnace to 800 to 1000° C. The rock melts and the contained water evaporates simultaneously. The viscous melt is expanded to 10-times to 20-times the initial volume by means of the water vapor pressure and is carried upwards out of the hot reaction zone very quickly due to the large airflow. Due to the quick cool-down, which takes place in this way, the expanded melt solidifies into grains with a grain size of, e.g., 0 to 5 mm. Expanded perlite has a low grain strength and bulk densities of 50 to 300 kg/m³, in particular 60 to 250 kg/m³.

Prior to the expansion process, the perlite can be treated with silicate, borate and/or phosphate glass, preferably in a quantity of 2 to 3% by weight, based on the unexpanded perlite, and in particular by adding a nitrogen source, in particular a nitride, in order to obtain the expanded perlite.

Lightweight materials, which can be obtained from a mixture of waste glass or silicon oxide and crude perlite, respectively, in a thermal expansion process and which have bulk densities between 80 and 300 kg/m³, in particular in particular 80 and 250 kg/m³ (waste glass or silicon dioxide/crude perlite mixture, respectively), can also be used.

Further suitable lightweight aggregates can be obtained from plant materials, such as, e.g., wood wool/chips, expanded corn (popcorn), foamed wood fibers and plant husks, in particular rice husks. They have low bulk densities of below 500 kg/m³.

The rice husk ash can also be used as lightweight aggregate without further processing.

In spite of the approval as lightweight aggregate according to DIN EN 13055-1, lightweight aggregates with bulk densities of below 250 kg/m³, in particular of expanded perlite and expanded mica, are not currently used in lightweight concretes. The main reason for this is that these lightweight aggregates are at least partially destroyed and have a very high absorbency behavior during the mixing process due to the reduced grain strength associated therewith.

Expanded perlite, expanded shale, expanded clay, expanded glass, rice husk ash, and the mixtures thereof, in particular with bulk densities of 40 to 1000 kg/m³, preferably between 50 to 500 kg/m³, and in particular 60 to 300 kg/m³, are particularly preferred as lightweight aggregates.

Concrete additives in terms of this invention are additives, which are added to the lightweight concrete mixture in small quantities and which are preferably already added during the production of the suspension mixture in order to improve the chemical or physical properties of the lightweight concrete mixture or the properties of the lightweight concrete.

Concrete additives are, e.g., concrete plasticizers, plasticizers, air entraining agents, sealing agents, retarders, accelerators, pressing aids, hydrophobing agents, stabilizers, fibers, or shrinkage reducers.

To be emphasized as concrete additives are here:
as concrete plasticizer: polycarboxylates, in particular polycarboxylate ether, lignin sulfonates (also lignosulfonic acid), melamine formaldehyde sulfonates, naphthalin formaldehyde sulfonates, hydroxycarboxylic acids, and the salts thereof,
as air entraining agents surfactants: such as, e.g., surface-active substances on the basis of modified natural products, for instance wood rosin soaps,
hydrophobing agents, such as siloxanes/alkyl alkoxy silanes, fatty acids, fatty acid salts, polymers (synthetic resin dispersions),
fibers with a fiber length of 2 to 18 mm. The fibers can consist of organic polymers (such as polyamides, such as, e.g., aramid or polyolefins, such as, e.g., polypropylene), glass, coal, steel, or basalt. Mixtures of different fibers can also be used, wherein the fibers are used together with the lightweight aggregates,
filler materials in the form of rock flour (grain size smaller than 0.063 mm), particularly preferably in the form of lime stone powder or quartz powder,
filler materials in the form of rock particles 0 to 2 mm (grain size) with gross densities starting at 2000 kg/m³ (according to DIN EN 12620 and DIN 1405-2). They can consist of quartz rock, greywacke, basalt, dolomite, volcanic rock, slate (clay slate), and other, also recycled (according to DIN EN 12620:2008-07) rock particles.

The lightweight concrete can be confectioned by the ratio of lightweight aggregate to rock particles in a range of the dry gross density of 200 kg/m³ to 1999 kg/m³ and by the type and addition quantity of the binder composition as well as the quantity of water with regard to the compression strength. The lightweight concrete can be set, e.g., to be pumpable and sprayable.

The method for producing comprises a two-stage mixing; a first mixing for producing a binder suspension and a second mixing comprises the mixing of the binder suspension produced in this way with at least the lightweight aggregates. The binder suspension comprises at least the binder mixture and water.

The (first) mixing with a high-speed stirring tool differs from the (second) mixing with a low-speed stirring tool in that the circumferential speed during the mixing with the high-speed stirring tool is at least 3-times as high.

The first stage of the mixing takes place with a high-speed stirring tool and has, e.g., a rotational speed of greater than 100 U/min, in particular 150 U/min. A circumferential speed of the stirring tool is suitably present between 3 and 20 m/s, preferably between 8 and 17 m/s.

The second stage of the mixing takes place with a low-speed stirring tool and has, e.g., rotational speeds of below 60 U/min, in particular below 45 U/min, e.g., 15 to 25 U/min. The circumferential speed of the stirring tool is preferably present between 0.9 and 1.25 m/s, preferably between 0.3 and 0.8 m/s.

The circumferential speed of the stirring tool in each case refers to the longest possible circumference when paddles of different length are used, e.g., as stirring tool. If several stirring tools or stirring zones are present in a mixer, the stirring tool with the higher circumferential speed or Froude number is relevant. The rotational speed of the stirring tool is a less suitable measure because the mixing effect also depends strongly on the geometry of the stirring tool.

The dimensionless characteristic number according to William Froude, which specifies a measure of the ratio between inertia and gravity and which is generally divided into supercritical (mixing material acceleration>gravity acceleration; Froude number above 1.0) and subcritical (mixing material acceleration<gravity acceleration; Froude number below 1.0), is suitable to describe the mixing.

The Froude number Fr is determined by the following mathematical relationship:

$$Fr = {ω}^{2} * r / g \\ ω = 2 * π * n$$

w=angular speed in rad/s
r=radius in m
g=gravitational acceleration in m/s²
d=diameter
n=rotations per s

when solving the formulate further, what results is:

$$Fr = d * {n}^{2} * 2 * {π}^{2} / g -> 2 * {π}^{2} / g = 2 * {3.14}^{2} / 9.81 = 2 \text{.01} -> Fr = d * {n}^{2} * 2.01$$

In suspension mixers, the circumferential speed of the mixing tools is specified:

$$v = d * π * n and n = v / ( π * d )$$

accordingly, the following also works:

$$Fr = {v}^{2} * 2 / ( d * g )$$

The first mixing in particular takes place so that the Froude number for producing the suspension mixture is greater than 10, preferably greater than 25, and most preferably greater than 40.

The second mixing in particular takes place so that the Froude number for producing the lightweight concrete mixture is smaller than 2, in particular smaller than 1.5.

The suspension mixture preferably has a flowability of at least F6. At the end of the second mixing, the lightweight concrete mixture preferably has a flowability of at least F2, preferably at least F4.

A suspension mixer, occasionally also referred to as colloidal mixer, is suitable for producing the suspension mixture, i.e., the first mixing.

The suspension mixer comprises a high-speed stirring tool. The high-speed stirring tool preferably has rotational speeds of above 300 U/min, in particular 800 to 2000 U/min. A circumferential speed of the stirring tool suitably between 3 and 20 m/s, preferably between 8 and 17 m/s is present.

A particularly suitable suspension mixer, referred to therein as colloidal mixer, is known from the DE 10354888 B4. In that regard, reference is made to the disclosure and definition of the suspension mixer therein and this is hereby also made the subject matter of the present property right. The suspension mixer has an upper more large-volume premixing and a lower more small-volume dispersing zone and a two-part separating element, comprising a guide ring and a baffle plate, which spatially limits the different zones from one another. The premixing and the dispersing zone are each equipped with separate stirrers. The stirring paddle of the dispersing zone push the mixing material against the baffle plate, which is arranged above the stirring paddle zone of the dispersing zone and which has a circular recess in the center. The mixing material subsequently strikes against the guide ring, which is arranged above the baffle plate and which has a smaller diameter than the baffle plate with regard to its outer and inner diameter. The mixing material pushes along the guide ring to the outside and to the top and is thereby pushed into the premixing zone by means of a circumferential outer ring slit between guide ring and mixer inner wall. The mixing material subsequently collapses in the center of the premixing zone and thus reaches through the first separating element, viewed from the top, the guide ring, back into the dispersing zone.

A further suitable suspension mixer is known from the DE 102011102988 A1, having an upper circulation zone/premixing zone and a lower dispersing zone, wherein at least one mixing tool comprising mixing axis and mixing paddles is added first in the dispersing zone, and at least one separating element, which spatially separates circulation zone and dispersing zone from one another, and the separating element releases at least one outer passage at a distance from the stirring axis and an inner passage close to the stirring axis, the inner passage accomplishes the material flow from the circulation zone in the dispersing zone and the outer passage accomplishes the material flow from the dispersing zone into the circulation zone, and the outer passage is arranged above the plane of the mixing paddles, wherein at least the outer passage can be changed in its (total) passage surface from the outside during the mixing process.

For this purpose, the suspension mixer according to the DE 102011102988 A1 preferably comprises two chambers (premixing zone and dispersing zone). The mixing material is passively moved in the premixing zone through the outlet of the liquid mixing material over a separating element, wherein the mixing material is initially sucked into the dispersing zone via a larger inlet in the separating element, preferably arranged above the axis of rotation. The mixing material is captured there by a high-speed stirrer and is pressed radially to the outside, preferably also to the top, wherein the mixing material thereby passes through smaller openings of the separating disk or through smaller openings between the outer edge of the separating disk and container wall, respectively, in the flow direction. The smaller openings are preferably arranged on the outer circumference of the separating disk. Smaller and larger hereby refer to the relative surface ratio of the smaller outlet openings to the larger inlet openings in the dispersing zone.

The second mixing comprises the mixing of the suspension mixture produced in this way with at least the lightweight aggregates. Free-fall mixers or conical mixers are suitable for this purpose when they are operated at a low rotational speed or low circumferential speed, respectively.

The free-fall mixer is available in different installation sizes. As small device with a volume of several liters, they are common in the do-it-yourself and partially also in the craft trade sector for the use at construction sites. In industrial installation sizes with 0.5 and more cubic meters of volumetric capacity, they are used in a stationary manner in ready-mixed concrete and prefabricated parts factories. The basic principle is the same. The mixing process takes place in a rotatable drum. In the drum, the loading also takes place through the drum opening. A spiral or blades, which are fastened in a stationary manner to the drum wall, which receives and raises a portion of the mixing material during each rotation, is located in the interior of the drum.

Conical mixers have lateral scrapers on the lower cone wall and a centric shaft comprising an Archimedean screw and/or slanted paddles fastened to the centric shaft and/or a combination thereof. This mixer type comprising a mixing chamber, which narrows conically to the bottom, is characterized in that the mixing material is transported from the bottom to the top during the mixing due to the structural shape and detaches laterally from the screw/the paddles due to the structural shape and moves to the bottom again in free fall via gravity.

The centrically arranged shaft/axis as well as the scraper can be operated at a different rotational speed. Depending on the set rotational speed, the conical mixer is thus able to operate with a Froude number of greater than 10 or greater than 25 as well as smaller than 2.5 or also smaller than 1.5.

In the case of the method according to the invention for producing the lightweight concrete mixture, 2 different mixer types or one mixer, respectively, are used in parallel and/or in succession, by means of which a suspension mixture is mixed at a Froude number of greater than 10 and rock particles and further materials are optionally added and the lightweight aggregates, even with a low bulk density and grain strength, are subsequently homogenized in a manner, which is gentle on the material, with the remaining mixing material with a Froude number of smaller than 2.5.

According to a preferred embodiment, the lightweight concrete, when it is produced as building element, has cover layers on at least one, preferably on both main surfaces (thus the two large surfaces of the building element). Prior to the introduction of the lightweight concrete according to the invention into a mold (e.g., a formwork), a first layer, which is tinner compared to the lightweight concrete mixture according to the invention, of a different, hydraulically hardening material, can be introduced with a predetermined application strength, onto which the lightweight concrete according to the invention is applied, connects, and hardens. After corresponding strength and/or hardening, a second layer of the same or a different hydraulically hardening material, which likewise connects to the lightweight concrete according to the invention, can be applied. Elements, which are coated on one and/or on both sides with a cover layer, can thus be produced easily, quickly, and cost-effectively. The hydraulically hardening material can be a so-called plaster system, comprising a plaster mortar.

Such a cover layer can also consist, for example, of a set inorganic plaster binder, also a plaster binder slurry. A reinforcement, in particular in the shape of a fiber mat, can preferably be embedded in the cover layer. The fiber mat can consist of fiberglass, carbon fibers, and/or basalt fibers. The fiber mat can in particular also be provided first solely in edge or flange regions, respectively, of the building element, in order to stabilize the flanges.

It is likewise possible to already insert fiber mats for protection against shrinkage cracks and as primer for following coatings in the production process, prior to filling the lightweight concrete mixture according to the invention into the formwork, or to apply it after the at least partial hardening. The preparations can thus already be made for subsequent surface treatments on both sides.

It is also possible to first introduce a lightweight concrete mixture according to this invention into the formwork, which, as lightweight concrete mixture, with corresponding density and compression strength, can take over static functions on the building, and to apply a highly insulating lightweight concrete with a low density, produced according to this invention, to this compression-proof lightweight concrete. A commercially available adhesion-promoting agent can be applied for an improved adhesion between the different lightweight concretes, but it is also possible to work “wet-on-wet” and to thus forgo the adhesion-promoting agent. It is likewise possible to apply a compression-proof lightweight concrete to the highly insulating lightweight concrete again. A sandwich is thus created, in the case of which the compression-proof lightweight concretes take over the static and protective function, and the highly insulating lightweight concrete of low density takes over insulation and additional sound protection.

With the introduction of different concrete densities at different points of a building component, a so-called gradient concrete can be produced, wherein concrete is used, where this is required statically, with higher density and compression strength, and lightweight concrete according to this invention is used at those points where heat insulation and/or weight savings plays a role, for example, wherein the transition of different concrete types can generally also take place continuously or wet-on-wet, respectively.

In the above-described way, 2 layers of normal concrete of any concrete quality with regard to density and compression strength can also be used, in that the lightweight concrete according to the invention is applied to the first normal concrete layer in each desired layer thickness and a normal concrete of any concrete quality with regard to density and compression strength is applied again as last layer. The lightweight concrete according to the invention thus fulfills the function of the heat-/and/or additional sound insulation in this sandwich element, the normal concrete fulfills static and functional properties.

It is furthermore possible to introduce a lightweight concrete of lower density compared to normal concrete into the pouring mold first, to attach or insert, respectively, a commercially available insulation thereon, such as, for example, mineral foam of low density (<100 kg/m³), mineral fiber insulation boards, polyurethane insulation boards, hard foam boards, polystyrene hard foam boards, cork boards, wood fiberboards, cellulose fiberboards, sheep's wool, wood wool, etc., and again a lightweight concrete according to this invention thereon, and to permanently connect the two lightweight concretes by means of connecting means, which are set in concrete, wherein the densities and compression strengths of the lightweight concretes can be different. The more compression-proof lightweight concrete can take over, for example, static functions as interior shell of a sandwich facade.

Prior to the introduction of the lightweight concrete, supporting and static reinforcements can be introduced into the pouring mold. Also so-called supporting structures, as they are described in the EP 0808959 B1. The above-mentioned reinforcement types are placed into the casting mold prior to pouring in the lightweight concrete according to the invention, are enclosed by said lightweight concrete, and after the hardening of the lightweight concrete, take over the desired functions as transport aid, static functions, as well as connections and joining aids on the building.

All common supporting aids and connecting means can furthermore be set in concrete, in that they are introduced into the casting mold prior to filling in the lightweight concrete and are encased by it after being poured in.

Prior to the introduction of the lightweight concrete into the casting mold, all types of hollow bodies can furthermore also be introduced in order to attain a further weight reduction of the building product, which is made of the lightweight concrete according to the invention.

For the accelerated and/or controlled hardening, the lightweight concrete can be moved into a climatic chamber after pouring into a mold, in particular a formwork. A hardening climate, which can be set with regard to the chamber temperature, depending on the used binders, to 30 to 85° C., in particular 35 to 60° C., can be set in this climatic chamber by means of warm air and/or hot steam. The hardening process can be accelerated thereby, e.g., in such a way that the lightweight concrete can already be removed from the mold after 4 hours.

In the case of dry gross densities starting at 1200 kg/m³, the residual moisture of the lightweight concretes is preferably below 16% by weight, particularly preferably below 14% by weight or even below 13% by weight.

### Experimental Part

The following raw materials were used in the experiment examples:
Cement: CEM I 52,5R, by Holcim
Cement: CEM II 42,5R, by Holcim
Cement: CEM II B-S 52,5R, by Holcim
Cement: CEM III B 42,5L-LH Aqua 4, by Holcim
Fly ash: HP, by Baumineral
Ground granulated blast furnace slag: by Holcim Werk Bremen
Micro silica: Silicoll P, by Sika
Lime stone powder (rock flour): @-Powder, by Bauminerale
Hydrophobizer: Protec HWA (ST) HA-BE, Ha-Be Betonchemie GmbH, Hameln, Germany (stearate)
CaO (calcium oxide): WFK 11/6, by Felswerke
Plasticiser: PCE Powerflow 5101, by MC-Bauchemie
Plasticiser: ACE 430, by BASF SE
Accelerator: Fastkick 111, by MC-Bauchemie
Stabilizer: Centrament 520, by MC-Bauchemie
Foaming agent: SB 2, by Mapei
Activator: sodium silicate: by Impag
Fibers: 6 to 18 mm SikaFiber PPM-12, by Sika. (micro-polypropylene fibers)
SRA: shrinking reduction agent: Centrament SRA 1, by MC Bauchemie
Rock particles with the grain size 0 to 2 mm: sand by Manzke Baustoffe
Rock particles with the grain size 0 to 5 mm: gravel by Manzke Baustoffe
Rock particles with the grain size 2 to 8 mm: gravel by Manzke Baustoffe
Recycling brick chippings 2-8 mm: by Manzke Baustoffe
Lightweight aggregate 1: expanded perlite with the grain size 0-5 mm, by Perliopol
Lightweight aggregate 2: Fibo ExClay with the grain size 2-5 mm (expanded clay)

Unless otherwise specified, the DIN EN 13055 and the test methods specified there are to be used for determining the technical properties of the listed lightweight aggregates.

### Experimental Procedure

The production of the below-described compositions 1 and 2 took place so that water was added first in a suspension mixer according to DE 102011102988 A1 (20 I=maximum mixing volume of the mixer), the stirrer was turned on, and cement, the fly ash, and the concrete additives were added successively. The mixing took place in the suspension mixer with a Froude number of 48.3 (mixing paddle speed, circumferential speed 8 m per second based on the three rotating paddles) to form a suspension mixture within 240 sec. (starting after the cement addition). The suspension mixture had a flowability of greater than F6.

The suspension mixture was then filled directly into a free-fall mixer (by Atika, 50 I=maximum mixing volume of the mixer), in which the lightweight aggregates with a water-hydrophobizer mixture (300 grams of water per kg of lightweight aggregate 1) were already added first and premixed together with the fibers. The suspension mixture, lightweight aggregate 1 and fibers were homogenously mixed in the free-fall mixer with a Froude number of 0.3 (drum rotation 0.5 rotations per second). 30 I of lightweight concrete mixture was obtained after 180 sec. (starting after the addition of the suspension mixture).

The flowability was in each case defined via the slump classes F1 to F6 according to DIN EN 12350-5. The dry gross density was measured according to DIN EN 12390-7 in the heating cabinet at 105° C. The water/binder value (W/B) value is the ratio between the mass of the water and the mass of the binder, wherein the lime stone powder (if used), micro silica and CaO such as the fly ash was added to the binder.

Water for the prewetting of lightweight aggregates is not contained in the compositions.

The portion on 1000 liters/m³ missing in the following tables were the air voids contained in the lightweight concrete.

### Composition 1 According to the Above Experimental Procedure:

| | % by | | | |
|---|---|---|---|---|
| | weight | kg/m³ | density | liter/m³ |
| Water | 19.51 | 74.48 | 1.00 | 74.48 |
| Cement CEM I 52, 5R | 49.38 | 188.48 | 3.10 | 60.80 |
| Fly ash | 8.86 | 33.82 | 2.40 | 14.09 |
| CaO (concrete additive) | 2.49 | 9.50 | 2.40 | 3.96 |
| Hydrophobizer | 0.12 | 0.46 | 1.00 | 0.46 |
| Plasticiser (concrete additive) | 1.89 | 7.22 | 1.00 | 7.22 |
| Foaming agent (concrete | 0.03 | 0.11 | 0.0007 | 175.38 |
| additive) | | | | |
| Lightweight aggregate 1 | 16.92 | 64.60 | 0.10 | 646.00 |
| Fibers | 0.80 | 3.04 | 1.00 | 3.04 |
| total: | 100.00 | 381.71 | | 985.43 |

The lightweight concrete mixture had a flowability of F6 as well as a water to binder value of 0.32. The lightweight concrete produced in this way had a dry gross density of 351 kg/m³ and an average compression strength of 2.5 N/mm² as well as a heat conductivity (lambda value A) of 0.095 (W/m²K).

### Composition 2

| | % by | | | |
|---|---|---|---|---|
| | weight | kg/m³ | density | liter/m³ |
| Water | 21.41 | 139.17 | 1.00 | 139.17 |
| Cement CEM I 42, 5R | 49.25 | 320.13 | 3.10 | 103.27 |
| CaO (concrete additive) | 2.01 | 13.07 | 2.40 | 5.44 |
| Fly ash | 8.03 | 52.20 | 2.40 | 21.75 |
| Hydrophobizer | 0.56 | 3.64 | 1.00 | 3.64 |
| Plasticiser (concrete additive) | 0.52 | 3.38 | 1.00 | 3.38 |
| Foaming agent (concrete | 0.0165 | 0.11 | 0.0007 | 165.00 |
| additive) | | | | |
| SRA (concrete additive) | 0.51 | 3.32 | 1.00 | 3.32 |
| Lightweight aggregate 1 | 8.10 | 52.65 | 0.10 | 526.50 |
| Rock particles 2-8 mm | 9.29 | 60.39 | 2.65 | 22.79 |
| Fibers | 0.30 | 1.95 | 1.00 | 1.95 |
| total | 100 | 650.01 | | 996.21 |

produced according to the above experimental procedure, except that the lightweight aggregates, together with the fibers and the rock particles, were added first in the free-fall mixer.

The lightweight concrete mixture had a flowability of greater than F6 as well as a water to binder value of 0.36.

The lightweight concrete produced in this way had a dry gross density of 581 kg/m³ and an average compression strength of 7.8 N/mm² after 28 days.

For the compositions 3 and 4, the production took place so that water was first added first in a suspension mixer according to DE 102011102988 A1 (20 I), the stirrer was turned on, and added were one after the other:
a) for composition 3: cement, fly ash, rock particles 0-2 mm, and the concrete additives, and
b) for composition 4: cement, lime stone powder, micro silica, and rock particles 0-2 mm, and the concrete additives.

The mixing took place in the suspension mixer with a Froude number of 91.4 (mixing paddle speed, circumferential speed 13 m per second) to form a suspension mixture within 240 sec. (starting after the cement addition). The suspension mixture had a flowability of greater than F6.

The suspension mixture was then filled directly into a free-fall mixer (by Atika, 501), in which the rock particles 2-8 mm were already added first and premixed together with the fibers. While the free-fall mixer continued to mix, the suspension mixture was then added at 50%, followed by 50% of the lightweight aggregate 1, then the remaining 50% of the suspension mixture, and subsequently the remaining lightweight aggregate 1. The mixing in the free-fall mixer took place with a Froude number of 0.3 (0.5 rotations per second). 30 I of lightweight concrete mixture was obtained after 240 sec. (after addition of the suspension mixture).

### Composition 3:

| | % by | | | |
|---|---|---|---|---|
| | weight | kg/m³ | density | liter/m³ |
| Water | 15.10 | 203.85 | 1.00 | 203.85 |
| Cement CEM II B-S 52, 5R | 31.1 | 419.85 | 3.05 | 137.66 |
| Fly ash | 6.80 | 91.80 | 2.40 | 38.25 |
| Lightweight aggregate 1 | 3.90 | 52.65 | 0.138 | 381.52 |
| Fibers | 0.08 | 1.08 | 1.00 | 1.08 |
| Plasticiser (concrete additive) | 0.38 | 5.13 | 1.00 | 5.13 |
| Accelerator (concrete additive) | 0.30 | 4.05 | 1.00 | 4.05 |
| Rock particles 0-2 mm | 28.20 | 380.70 | 2.65 | 143.65 |
| Rock particles 2-8 mm | 14.04 | 189.54 | 2.65 | 71.52 |
| Stabilizer (concrete additive) | 0.10 | 1.35 | 1.00 | 1.35 |
| total | 100.00 | 1350.00 | | 988.06 |

The lightweight concrete mixture had a flowability of greater than F6 as well as a water to binder value of 0.40.

The lightweight concrete produced in this way had a dry gross density of 1.214 kg/m³ and an average compression strength of 28 N/mm² after 28 days.

### Composition 4:

| | % by | | | |
|---|---|---|---|---|
| | weight | kg/m³ | density | liter/m³ |
| Water | 10.71 | 192.78 | 1.00 | 192.78 |
| Cement: CEM I 52, 5R | 21.05 | 378.90 | 3.05 | 124.23 |
| Lime stone powder <0.63 mm | 3.75 | 67.50 | 2.65 | 25.47 |
| Micro silica | 1.40 | 25.20 | 2.40 | 10.50 |
| Lightweight aggregate 1 | 2.10 | 37.80 | 0.168 | 225.00 |
| Rock particles 0-2 mm | 40.4 | 727.20 | 2.65 | 274.42 |
| Rock particles 2-8 mm | 20.2 | 363.60 | 2.65 | 137.21 |
| Fibers | 0.06 | 1.08 | 1.00 | 1.08 |
| Plasticiser | 0.33 | 5.94 | 1.00 | 5.94 |
| total | 100.00 | 1800.00 | | 996.62 |

The lightweight concrete mixture had a flowability of greater than F6 as well as a water to binder value of 0.41.

The lightweight concrete produced in this way had a dry gross density of 1.649 kg/m³ and an average compression strength of 48 N/mm² after 28 days.

For the compositions 5 and 6, the production took place so that water was added first in a suspension mixer according to DE 102011 102988 A1 (20 I), the stirrer was turned on, and added were one after the other:
a) for composition 5: cement, rock particles 0-2 mm, and the concrete additives, and
b) for composition 6: cement, fly ash, and the concrete additives

The mixing took place in the suspension mixer with a Froude number of 91.4 (mixing paddle speed circumferential speed 13 m per second) to form a suspension mixture within 240 sec. (after cement addition). The suspension mixture had a flowability of >F6.

For composition 5, 50% of the suspension mixture were then filled directly into a conical mixture (by Kniele, 100 |=maximum mixing volume of the mixer), in which the lightweight aggregate 2 together with the fibers were already provided and premixed. The remaining 50% of the suspension mixture and subsequently the lightweight aggregate 1 were then added, this mixture was mixed homogeneously during the entire mixing with a Froude number of 0.9 (1.2 screw rotations per second). 50 I of lightweight concrete mixture was obtained after 240 sec. (after addition of the suspension mixture).

The lightweight concrete was moved for 20 h into a hardening chamber at 38° C. to 43° C. and was stripped afterwards.

### Composition 5:

| | % by | | | |
|---|---|---|---|---|
| | weight | kg/m³ | density | liter |
| Water | 13.75 | 195.25 | 1.00 | 195.25 |
| Cement: CEM III B 42, 5 L-LH | 25.10 | 356.42 | 3.05 | 116.86 |
| Lime stone powder <0.63 mm | 6.30 | 89.46 | 2.65 | 33.76 |
| Lightweight aggregate 2 | 21.90 | 310.98 | 1.28 | 242.95 |
| Lightweight aggregate 1 | 3.15 | 44.73 | 0.187 | 239.20 |
| Fibers | 0.32 | 4.54 | 1.00 | 4.54 |
| Plasticiser | 0.32 | 4.54 | 1.00 | 4.54 |
| Accelerator | 0.31 | 4.40 | 1.0000 | 4.40 |
| Rock particles 0-2 mm | 28.65 | 406.83 | 2.65 | 153.52 |
| Shrinkage reducer SRA | 0.20 | 2.84 | 1.00 | 2.84 |
| total | 100.00 | 1419.99 | | 997.86 |

The lightweight concrete mixture had a flowability of F6 as well as a water to binder value of 0.44.

The lightweight concrete produced in this way had a dry gross density of 1.275 kg/m³ and an average compression strength of 34 N/mm² after 28 days.

For the composition 6, 50% of the suspension mixture was filled, as described above, into a conical mixer (by Kniele, 100 |=maximum mixing volume of the mixer), in which the recycling brick chippings were already added first and premixed together with the fibers and the rock particles 0-2 mm. The remaining 50% of the suspension mixture were then added, followed by lightweight aggregate 1, this mixture was homogenously mixed during the entire mixing with a Froude number of 0.9 (1.2 screw rotations per second). 50 I of lightweight concrete mixture was obtained after 240 sec. (after addition of the suspension mixture). The lightweight concrete was filled into molds and was moved for 20 h into a hardening chamber, which was temperature-controlled to approximately 40° C. and was stripped afterwards.

### Composition 6:

| | % by | | | |
|---|---|---|---|---|
| | weight | kg/m³ | density | liter |
| Water | 13.52 | 223.08 | 1.00 | 223.08 |
| CEM III B 42, 5 L-LH | 2.5 | 354.75 | 3.05 | 116.31 |
| Lime stone powder <0.63 mm | 4.60 | 75.90 | 2.65 | 28.64 |
| Fly ash | 5.80 | 95.70 | 2.40 | 39.88 |
| Lightweight aggregate 1 | 2.76 | 45.54 | 0.260 | 175.15 |
| Recycling brick chippings | 51.03 | 842.00 | 2.10 | 400.95 |
| Fibers | 0.05 | 0.83 | 1.00 | 0.83 |
| Plasticiser (concrete additive) | 0.25 | 4.13 | 1.00 | 4.13 |
| Stabilizer (concrete additive) | 0.24 | 3.96 | 1.0000 | 3.96 |
| Accelerator (concrete additive) | 0.25 | 4.13 | 1.00 | 4.13 |
| total | 100 | 1650.02 | | 997.06 |

The lightweight concrete mixture had a flowability of greater than F6 as well as a water to binder value of 0.42.

The lightweight concrete produced in this way had a dry gross density of 1.551 kg/m³ and an average compression strength of 42 N/mm² after 28 days.

For the composition 7, the production took place so that water was provided first into the suspension mixer according to DE102011102988 A1 (20 I) and ground granulated blast furnace slag and activator were added. Both was premixed and the addition of the fly ash and of the concrete additives took place thereafter. The mixing took place in the suspension mixer with a Froude number of 91.4 (mixing paddle speed, circumferential speed 13 m per second) to obtain the suspension mixture within 240 sec. (after ground granulated blast furnace slag addition). The suspension mixture had a flowability of greater than F6.

50% of the suspension mixture were then filled into a conical mixer (by Kniele, 100 I), in which the rock particles 2 with fibers were already provided. Under continuous mixing, 50% of the lightweight aggregate 1 was then added, followed by the remaining 50% of the suspension mixture, and subsequently the remaining lightweight aggregate 1.

The mixture was mixed in the conical mixture for the entire time with a Froude number of 0.9 (1.2 screw rotations per second). 50 I of lightweight concrete mixture was obtained after 240 sec. (after addition of the suspension mixture). The lightweight concrete was filled into molds and was moved for 20 h into a hardening chamber, which was temperature-controlled to approximately 40° C. and was stripped afterwards.

### Composition 7:

| | % by | | | |
|---|---|---|---|---|
| | weight | kg/m³ | density | liter |
| Water | 15.41 | 259.90 | 1.00 | 259.9 |
| Ground granulated blast furnace | 28.44 | 480.00 | 2.90 | 165.52 |
| slag | | | | |
| Fly ash | 5.04 | 85.00 | 2.40 | 35.42 |
| Lightweight aggregate 1 | 3.73 | 63.00 | 0.260 | 242.31 |
| Rock particles 0-2 mm | 44.02 | 743.00 | 2.65 | 280.38 |
| Fibers | 0.05 | 0.83 | 1.00 | 0.83 |
| Plasticiser (concrete additive) | 0.24 | 4.13 | 1.00 | 4.13 |
| Stabilizer (concrete additive) | 0.23 | 3.96 | 1.0000 | 3.96 |
| Activator | 2.84 | 48.00 | 1.00 | 4.13 |
| total | 100 | 1687.82 | | 996.58 |

The lightweight concrete mixture had a flowability of greater than F6 as well as a water to binder value of 0.46. The lightweight concrete produced in this way had a dry gross density von 1.540 kg/m³ and an average compression strength of 38 N/mm² after 28 days.

For the composition 8, the production took place so that firstly cement, the rock particles 0-2 mm, the lime stone powder, the concrete additives, the fibers, and the water, as well as the concrete additives were added first in this order in a conical mixer (by Kniele, 100 I=maximum mixing volume of the mixer), the stirrer was turned on, and were homogeneously mixed with a Froude number of 29.5 (7.0 screw rotations per second) for 180 sec. The lightweight aggregate 2 was subsequently filled in at the same mixing speed and was mixed for a total of further 180 sec. With a Froude number of 0.9 (1.2 screw rotations per second), the lightweight aggregate 1 was subsequently homogenously mixed with the constituents of the lightweight concrete mixture within 240 sec. (after addition of the lightweight aggregate 1) to form a lightweight concrete mixture.

The lightweight concrete was filled into molds and was moved for 20 h into a hardening chamber, which was temperature-controlled to approximately 40° C. and was stripped afterwards.

### Composition 8:

| | % by | | | |
|---|---|---|---|---|
| | weight | kg/m³ | density | liter |
| Water | 13.75 | 218.62 | 1.00 | 218.62 |
| Cement: CEM III B 42, 5 L-LH | 26.33 | 419.19 | 3.05 | 104.65 |
| Lime stone powder <0.63 mm | 6.29 | 100.20 | 2.65 | 37.81 |
| Lightweight aggregate 2 | 21.89 | 348.30 | 1.28 | 272.12 |
| Lightweight aggregate 1 | 2.00 | 31.8 | 0.187 | 170.05 |
| Fibers | 0.32 | 5.08 | 1.00 | 5.08 |
| Plasticiser | 0.32 | 5.08 | 1.00 | 5.08 |
| Accelerator | 0.31 | 4.93 | 1.00 | 4.93 |
| Rock particles 0-2 mm | 28.62 | 455.65 | 2.65 | 171.94 |
| Shrinkage reducer SRA | 0.20 | 3.18 | 1.00 | 3.18 |
| total | 100.00 | 1592.03 | | 993.46 |

The lightweight concrete mixture had a flowability of F4 as well as a water to binder value of 0.42. The lightweight concrete produced in this way had a dry gross density of 1.489 kg/m³ and an average compression strength of 31 N/mm² after 28 days.

It was surprisingly found during the series of experiments that for the production of lightweight concrete according to this invention, when using the same amounts of CEM III B 42,5 L cement instead of CEM | 52,5 R cement, virtually identical strength values with regard to the early strength in the range of hours up to 24 h and the final strength were attained after 28 days, when during the production of the binder paste, a CEM III B 42,5 cement was mixed with Froude number >100 also including the rock particles up to 2 mm from the formula, and the hardening of the produced products took place in a chamber at a constant temperature of 40° C.

The strength increases compared to the mixing without rock particles were 51% after 20 h and =27% after 28 days.

1. A method for producing a lightweight concrete mixture, comprising at least the following steps:
(A) bringing together at least water and a binder composition,
wherein the binder composition comprises at least cement or geopolymers as binders, and mixing with a high-speed stirring tool to obtain a suspension mixture,
wherein the weight ratio of water to binder composition in the suspension mixture is 1:5 to 1:1;
wherein the binder accounts for at least 40% by weight of the binder composition,
wherein the binder is added as powdery solid, and
(B) bringing together the suspension mixture or portions of the suspension mixture with at least lightweight aggregates or portions of the lightweight aggregates, and
mixing with a low-speed stirring tool to obtain a lightweight concrete mixture,
wherein the lightweight aggregates have a bulk density of 40 to 1000 kg/m³, and
wherein the mixing with the high-speed stirring tool takes place at a circumferential speed, which is more than three times as high as the circumferential speed when mixing with the low-speed stirring tool,
wherein the mixing with the slow-speed stirring tool is carried out in a free-fall mixer or a conical mixer.

2. The method according to claim 1, wherein the mixing with the low-speed stirring tool is carried out with a Froude number of less than 2.5.

3. (canceled)

4. The method according to claim 1, wherein the mixing with the high-speed stirring tool is carried out with a Froude number of greater than 10.

5. The method according to claim 1, wherein the mixing with the high-speed stirring tool to obtain the suspension mixture is carried out in a suspension mixer.

6. The method according to claim 1, wherein the mixing with the low-speed stirring tool and the mixing with the high-speed stirring tool is each carried out in the same conical mixer and with the same stirring tool at different circumferential speeds.

7. The method according to claim 1, wherein the binder is added to the suspension mixture only.

8. The method according to claim 1, wherein 20 to 70% by weight of the lightweight aggregates with 20 to 70% by weight of the suspension mixture are initially subjected to the mixing with the low-speed stirring tool and the remaining lightweight aggregates and the remaining suspension mixture are added subsequently in one or several steps by continuing the mixing with the low-speed stirring tool.

9. The method according to claim 1, wherein the water is provided first and the binder composition is added as powdery solid, when bringing together water and the binder composition.

10. The method according to claim 1, wherein the lightweight aggregates are provided first when bringing together the suspension mixture or a portion of the suspension mixture with at least lightweight aggregates or a portion of the lightweight aggregates.

11. The method according to claim 1, wherein to obtain the suspension mixture, fillers in the form of rock flour or rock particles 0-2 mm or both are added and the mixing with the high-speed stirring tool is carried out with a Froude number of greater than 50 for at least 30 sec.,
wherein if the rock flour is added, it is added in a quantity of 50 to 150 kg per m³ of lightweight concrete mixture,
wherein if the rock particles 0-2 mm are added, they are added in a quantity of 100 to 500 kg per m³ of lightweight concrete mixture.

12. The method according to claim 1, wherein to obtain the suspension mixture 0.1 to 4% by weight of plasticizer is added.

13. The method according to claim 1, wherein to obtain the suspension mixture, no lightweight aggregates are added.

14. The method according to claim 1, comprising bringing together the suspension mixture with a flowability of at least F6 with the lightweight aggregates and mixing with at least 1% by weight of lightweight aggregates.

15. The method according to claim 1, wherein 22 to 40% by weight of water is added to the suspension mixture.

16. The method according to claim 1, wherein the lightweight aggregates have a grain size in the range of 0 mm to 6 mm as grain groups according to DIN EN 13055.

17. The method according to claim 1, wherein the lightweight aggregates are selected from expanded perlite, expanded shale, expanded clay, expanded glass, waste glass or silicon dioxide/crude perlite mixture, respectively, rice husk ash, and mixtures thereof.

18. The method according to claim 1, wherein a hydrophobing agent is applied to the lightweight aggregates prior to being brought into contact with the suspension mixture.

19. The method according to claim 1, wherein the lightweight aggregates are wetted with water prior to being brought into contact with the suspension mixture.

20. The method according to claim 1, wherein the binder composition comprises ground granulated blast furnace slag as binder additive.

21. The method according to claim 1, wherein to obtain the suspension mixture, rock flour is added as filler with particle diameters of 0.001 mm to 0.1 mm.

22. The method according to claim 1, wherein the binder composition comprises fly ash as binder additive and cement as binder.

23. The method according to claim 1, wherein the binder composition is a geopolymer, comprising
2 to 25% by weight of alkali hydroxides or alkali silicates or both, and
75 to 98% by weight of ground granulated blast furnace slag;
or
2 to 20% by weight of alkali hydroxides or alkali silicates or both, and
60 to 78% by weight of ground granulated blast furnace slag, and
20 to 38% by weight of fly ash.

24. The method according to claim 1, wherein the binder composition comprises micro silica as binder additive and cement as binder and the micro silica is added in a quantity that the concentration of the micro silica accounts for 30 to 50 kg/m³ in the lightweight concrete mixture.

25. The method according to claim 1, wherein the binder composition comprises rice husk fly ash prepared by means of grinding as binder additive and cement as binder, and the rice husk fly ash accounts for 10 to 60% by weight of the binder composition.

26. The method according to claim 1, wherein caustically burnt CaO and caustically burnt MgO is added in a quantity of 1 to 5% by weight, based on the binder composition, to obtain the suspension mixture or the lightweight concrete mixture.

27. The method according to claim 1, wherein graphene in a quantity of 75 to 650 g/m³, based on the lightweight concrete mixture, is added to the lightweight concrete mixture.

28. The method according to claim 1, wherein the lightweight concrete mixture comprises rock particles with particle diameters of 0.01 to 8 mm according to DIN EN 12620.

29. The method according to claim 1, wherein with or after addition of the lightweight aggregates, fibers of organic polymers, glass, coal, steel, or basalt with a fiber length of 2 to 18 mm are added.

30. The method according to claim 1, wherein an air entraining agent is added to the lightweight concrete mixture.

31. A lightweight concrete mixture, obtained according to the method according to claim 1.

32. A method for obtaining lightweight concrete by hardening a lightweight concrete mixture, obtained according to the method of claim 1 comprising the hydraulic hardening of the lightweight concrete mixture in a mold.

33. The method according to claim 32, wherein the lightweight concrete mixture at least partially hardens into the lightweight concrete in the mold in a climatic chamber at 30° C. to 85° C.

34. The method according to claim 32, wherein the lightweight concrete has a dry gross density between 250 and 1.999 kg/m³.

35. The method according to claim 32, wherein the lightweight concrete has an A number of greater than 500.

36. The method according to claim 32, wherein the lower and the upper layer in the mold has a higher density than the following layer or the following layers located further inwards.

37. The method according to claim 32, wherein an insulation or a hollow body is introduced into the mold prior to or during the filling of the mold with the lightweight concrete mixture.

38. The method according to claim 32, wherein the lightweight concrete mixture is introduced into molds in block molding machines and is compressed by shaking or pressing or both and lightweight concrete blocks are obtained therefrom.

39. The method according to claim 32, wherein a reinforcement or a transport aid or both is placed into the mold.

40. A hardened lightweight concrete as component obtained according to the method according to claim 32.
